(19) United States
(12) Patent Application Publication
(10) Pub. No.: US 2013/0046541 A1
(43) Pub. Date: Feb. 21, 2013

(54) APPARATUS FOR ASSISTING VISUALLY IMPAIRED PERSONS TO IDENTIFY PERSONS AND OBJECTS AND METHOD FOR OPERATION THEREOF

(71) Applicants: Ronald L. Klein, Sarasota, FL (US); James A. Kutsch, JR., Morristown, NJ (US)

(72) Inventors: Ronald L. Klein, Sarasota, FL (US); James A. Kutsch, JR., Morristown, NJ (US)

(21) Appl. No.: 13/566,209

(22) Filed: Aug. 3, 2012

Related U.S. Application Data
(60) Provisional application No. 61/575,390, filed on Aug. 19, 2011.

(51) Int. Cl. G10L 13/08

(52) U.S. Cl. 704/260; 704/E13.011

(57) ABSTRACT

An apparatus for assisting visually impaired persons includes a headset. A camera is mounted on the headset. A microprocessor communicates with the camera for receiving an optically read code captured by the camera and converting the optically read code to an audio signal as a function of a trigger contained within the optical code. A speaker communicating with the processor outputs the audio signal.

### CROSS REFERENCE TO RELATED APPLICATION

The present application claims priority benefit under 35 U.S.C. §119(e) of U.S. Provisional patent application No. 61/575,390, filed Aug. 19, 2011, the disclosure of which is incorporated herein by reference.

### BACKGROUND OF THE INVENTION

The present invention is directed to a device for assisting the visually impaired to recognize objects and persons, and in particular, to a device which automatically and audibly identifies a person and object.

According to the provisional report of the 2010 National Health Interview Survey, 21.5 million Americans aged 18 or older report experiencing vision loss. Of those 21.5 million, many of these adults are categorized as legally blind, although they have some visual acuity. Legal blindness is defined as a visual acuity of 20/200 or less in the better eye, best correction possible. In other words, a legally blind individual may have some vision, but would have to stand 20 feet from an object to identify it with corrective lenses with the same degree of clarity as a normally sighted person could from 200 feet. Additionally, some people with average acuity may have a visual field of less than 20 degrees, which is also classified as being legally blind. Visual acuities from 20/70 to 20/200 are often categorized as low vision.

The legally blind or low vision persons (the “visually impaired”) have great difficulty in identifying people and things during the normal daily activities that sighted people take for granted. As a result, at a conference, they can not identify people in a group, even when those people are wearing badges with large print. At home, they have a hard time identifying objects in their cabinet, or more importantly distinguishing one bottle of medication from another when pharmacy bottles are identical, but for the printed label.

Methodologies and technologies have been developed to aid the visually impaired. They range from the use of assistance animals and special computer screens which amplify the text to a point almost unrecognizable by normally sighted individuals. For many years Braille has been used for identification, but not all blind or visually impaired people learn to read Braille. Another identification technique uses tactile devices, such as trinkets attached to things which act as defacto labels to help distinguish one object from another. These devices have been satisfactory in assisting visually impaired to traverse through the normal activities. However, they are often expensive, require some training, require memorization of dozens of tactile devices or come with the stigma that society often has for the disabled; which continue to set the visually impaired apart from the remainder of society.

There have been some technological advances such as text readers which scan text and convert the text which aid the blind and the visually impaired in reading documents. However, these devices are bulky, and do not lend themselves to use in social situations, or on round surfaces such as bottles, medicine vials or the like.

With the advent of optical codes, such as bar codes, quick response (QR) codes or the like, it is known to store links to websites or even some rudimentary text information therein. IDEAL Group Apps4Android, Inc. has released a software application for converting text encoded in bar codes to speech, utilizing a smartphone. This device is also satisfactory, and overcomes some of the shortcomings discussed above, but requires a visually impaired person to aim a smartphone at a code on a device and then listen to a public broadcast of the information stored in the code. Furthermore, it requires the user to hold the phone adjacent the object as it captures the code, preventing the performance of any task requiring the use of the hands. It also provides no flexibility as the information is limited to that information stored in the code on the object by the manufacturer.

Accordingly, a device for overcoming the shortcomings of the prior art is desired.

### BRIEF SUMMARY OF THE INVENTION

A device for identifying objects and persons includes a headpiece. A camera is mounted on the headpiece. A microprocessor is in communication with the camera, the camera capturing images of optical codes and transmitting the image to the processor. The processor converts the optical code to text, and determines whether the text is to be converted to speech. The processor converts the text to an audio signal as a function of the determination. An earpiece communicates with the processor and outputs the audio signal.

In a preferred embodiment of the invention, the code is a two-dimensional code. The code includes a symbol and/or text which indicates to the processor that the code is to be converted to an audio signal.

The code may also be formed of a material to provide texture to the code.

In one preferred embodiment of mode of operation, the camera captures the code. A user inputs text to be associated with the code at an audio input of the processor. The microprocessor maps the code to the audio input and stores the mapped pair in a database associated with the microprocessor. The microprocessor causes the text to be output as an audio output to the earpiece whenever the camera captures the code.

### BRIEF DESCRIPTION OF THE DRAWINGS

The present disclosure is better understood by reading the written description with reference to the accompanying drawing figures, in which the reference numerals denote the similar structure and refer to the elements throughout in which:

FIG. 1 is an exploded perspective view of a device for aiding the visually impaired constructed in accordance with the invention;

FIG. 2 is an optically readable code used in accordance with a first mode of operation of the invention;

FIG. 3 is an optically readable code used in accordance with a second mode of operation of the invention; and

FIG. 4 is a flow chart for the operation of the device in accordance with the invention.

### DETAILED DESCRIPTION OF THE PREFERRED EMBODIMENT

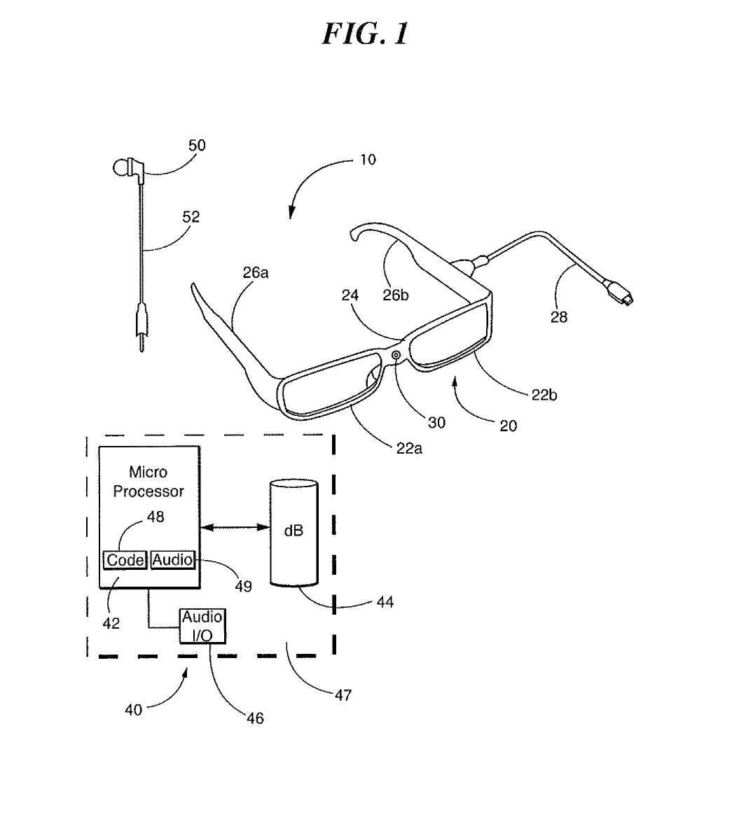

Reference is made to FIG. 1 wherein an apparatus, generally indicated as 10, for aiding the visually impaired constructed in accordance with the preferred embodiment of the invention is provided. Apparatus 10 includes a headset, generally indicated as 20 which supports a camera 30 thereon. In a preferred but non-limiting embodiment, the headset takes the form of eyeglasses which readily support the weight of camera 30 and has the added effect of providing a plurality of positions along the glasses where the camera may be mounted in a lightweight manner. Glasses 20 include lens supports 22a, 22b connected by a bridge 24. Ear supports 26a, 26b extend from the respective lens supports 22a, 22b as known in the art.

In a preferred but non-limiting embodiment, camera 30 is a camera, such as a laser scanner, charge coupled device (CCD) scanner of the like capable of capturing the image of an optically readable code. The camera is preferably mounted on bridge 24. In this way, the camera is supported at a point of optimum weight distribution and automatically follows movement of the head as visually impaired users generally target the area at which the code would be placed without needing to be able to focus on the code with their eyes.

In a preferred embodiment, the camera is lightweight and has both horizontal and vertical resolution. The viewing angle is at least about 30 degrees.

Camera 30 is in communication with a processor, generally indicated as 40, for processing video signals or still photographs output by camera 30. Processor 40 includes a microprocessor 42 in communication with a database 44. Microprocessor 42 includes a first module 48 for converting optical code images received from camera 30 into text, and a second module 49 for converting text to an audio output and converting audio input to text. Processor 40 includes an audio input/output 46 for inputting audio signals to be operated upon by microprocessor 42 and outputting audio signals generated by microprocessor 42. In a preferred embodiment, processor 40 may be a smartphone 47 for housing each of the elements of microprocessor 42, audio input/output 46 and database 44, as is known in the art.

An audio earpiece 50 communicates with processor 40 to receive audio signals output at audio input/output 46

In a preferred embodiment, communication between audio earpiece 50 and camera 30 with processor 40 is done wirelessly utilizing bluetooth or radio frequency communications, microwave or any other contemplated wireless communication capable of short distance communication of data. However, it is also contemplated that a cable 52 may connect earpiece 50 to processor 40. Similarly, a camera cable 28 may connect camera 30 to processor 40.

Generally, during use, an optically readable code containing text is captured by camera 30 and transmitted to processor 40. Microprocessor 42 converts the optically readable code to text. As a function of trigger text codes, the processor converts the text to an audio message which is transmitted to the earpiece so the visually impaired individual receives an audio message of the information stored within the code. In effect, the text of the code is read to the user. Alternatively as a function of trigger text codes, processor 40 may access database 44 to “read” information stored therein to the user.

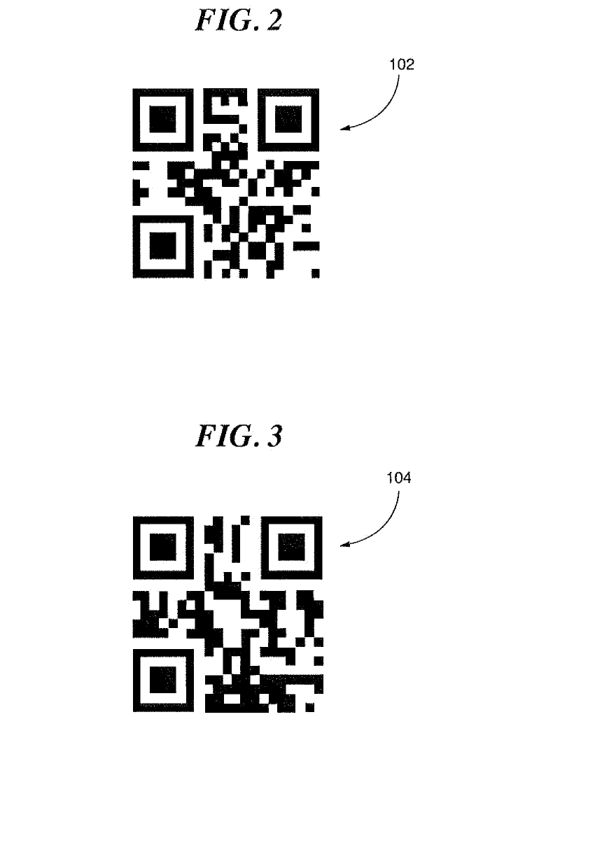

Reference is first made to FIGS. 2 and 3 wherein optical codes generally indicated as 102 and 104 constructed in accordance with the invention are provided. As will be seen, in a preferred but non-limiting embodiment, quick response (QR) optical codes are used. While QR codes have advantages in that they are easily read, store data efficiently, and are widely used by the general public, any optical code capable of performing as discussed below, such as barcodes, two dimensional barcodes, and ID matrix or the like may be used. QR codes are preferred because of their ability to be read at a distance, read on the fly, and they have a preferred data density.

In one non-limiting embodiment, QR codes 102, 104 are constructed to be readable from about 3% feet or less by the camera and have about 100 characters of text or less (not counting administrative overlay) out of a possible 4,296 to 7,089 in the characters. The use of a such low density code, allows the code to be read quickly and to be “written” in non-printed ways, even in three dimensions, such as with fabric; within clothing. Furthermore, the administrative portion of the code includes a trigger which notifies processor 40, that this is the type of optically readable code which is to be processed. In this way, because of the ubiquitous presence of optical codes, apparatus 10 prevents sensory overload by camera 30 inadvertently reading, and processor 40, relaying every code in the environment to the user, such as at a food store or even at home.

In a preferred embodiment, at least two distinct codes are utilized as trigger codes to indicate to processor 40 the type of processing to be performed on the individual code. For the purposes of this explanation, the first type of trigger is indicated as T1 and the second type of trigger is indicated as T2. The failure to include either trigger within the optical code causes processor 40 to ignore those signals from camera 30. By way of example, T1 trigger may be two dots and a space at the front end of the administrative overlay, or text portion of optical code 102. In contrast, the second trigger, T2 code may be four sequential dots and a space contained in the header of optically readable code 104.

In use, the primary difference between code 102 and code 104 is that code 102 contains information which may be converted and directly output to earpiece 50. However, even QR codes, particularly those having a low density (100 text characters or less) contemplated in this invention, do not often contain enough information to truly aid the visually impaired. In this case, code 104 contains look-up table information, i.e., a unique identifier, which can be used to unlock an address in database 44 where more information, than capable of being stored in the QR code itself, may be utilized. Therefore, in order to utilize code 104, a library of messages, each associated with a unique identifier contained in respective optical codes 104 must be created.

In a most common contemplated use, labels for use by the visually impaired may be created utilizing code 104 having the T2 trigger. In this way, a label may be created for items within the household, such as appliances, food containers, pill vials, or the like, all of which are difficult to distinguish by the visually impaired. A plurality of QR coded labels 104 are pre-formatted offline and may be printed onto an adhesive sheet. Each sheet contains multiple individual QR coded labels 104 in a non-limiting preferred embodiment which are generated with unique alphanumeric text information identifiers. In a preferred, but non-limiting embodiment, each code is not printed, but created in three-dimensions, such as with a fabric, or utilizing a variation of braille printing to create an optical code which may be touched and determined to be an optical code, yet still be read by a camera 30.

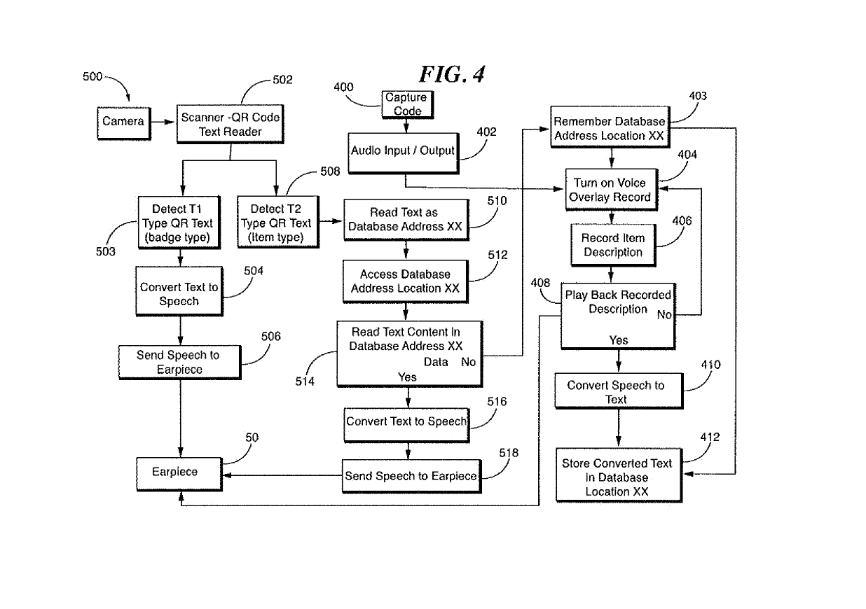

Reference is now made to FIG. 4, wherein the steps for initializing the system with code 104 are provided. A single optical code 104 is selected from a sheet of codes 104 and affixed to the item to be identified. Code 104 is first identified by the visually impaired user, who captures the code 104 optically with camera 30 in step 400. In a step 402, the user makes an audio command at audio/input device 46 of processor 40 to begin the initialization process which causes processor 40 to begin recording audio messages to be stored in database 44. In a preferred but non-limiting embodiment, this may be performed utilizing the microphone of a smartphone 47.

By way of example, if the label is to be attached to a jar of jelly, the user may record an item description in step 406 such as “concord grape jelly expires Jul. 26, 2012”. For medication, the name of the medication such as “Statin, 1 pill per day expires June 2013” may be recorded. The recorded message is then played back to the user at earpiece 50 in a step 408 to confirm accuracy. If the message is not correct, then the process is returned to 404 for repeating. If the recorded message is satisfactory, then in a step 410, microprocessor 42 utilizing speech to audio converter module 49 converts the audio message to text.

In a step 412, the converted text message is stored in database 44 at a known location. The message location within database 44 is mapped to the unique identifier information stored in optical code 104 as captured by camera 30 upon completion of step 412.

In contrast thereto, the type of information stored in optical code 102 is the type of information which is created for a specific purpose and has low density information. One example would be a name badge at a conference in which the information contained therein would be that information usually found at a conference such as the name of the attendee and their company organization. This is the type of information that belongs to the other party and is not the type of information which would be repeatedly used away from the badge by the user of system 10, and is more likely to be read on the fly.

During use, as a visually impaired person traverses their environment, they would turn on camera 30 in a step 500. This may be done by a vocal command at audio input/output 46. In a step 502 camera 30 scans and captures optical codes such as QR codes 102, 104. Microprocessor 42 determines whether or not the scanned optical code includes a trigger, if not, no processing of the code occurs; or the processing stops upon conversion of the code to text; or at some intermediate point at which processor 40 determines that no trigger is present.

If a T1 code is detected in step 503, then a microprocessor 42 utilizing module 48 converts the captured text and then converts the text to speech utilizing module 49. The text such as the name of a badge wearer, is then sent as an audio signal to earpiece 50 in a step 506. In this way, as the user approaches a person at a conference, the badge is captured by the camera, and the name of the person associated with the badge is said aloud in the ear of the wearer in a way that only the user may hear, thus, eliminating some of the stigma of being visually impaired. Because trigger T1 was detected, processor 40 recognizes that no search of the database was required, speeding up processing.

If a trigger T2 is detected in a step 508, then microprocessor 42 converts the code to text and the text is utilized by microprocessor 42 to identify the memory address within database 44 in a step 510. In a step 512, microprocessor 42 accesses database 44 and reads the text contents at that database address in a step 514. If there is no content at the indicated database address or the data therein is unretrievable or corrupted, then in a step 403, processor 40, in the form of a smartphone 47 by way of example, makes note of that database address and indicates to the user to begin the initialization process in a step 404 if necessary, or to store the converted text if it is also known in the database location in a step 412.

If there is data stored at the indicated corresponding database address location, then the retrieved text data is converted to speech by module 49 in a step 516 and in step 518, an audio signal is sent to earpiece 50 to announce the information associated with the item with which that code 104 is associated in the ear of the user.

It should be noted, that in the exemplary embodiment, microprocessor 42 first converts code to text and then converts text to an audio message. This is done to expedite the processing of codes having either triggers T1 or T2 with a unitary device 10. However, it is well understood that in connection with the code 102, there is no need to perform the intermediate text conversion steps so that the optical code may be converted directly to an audio output.

It should also be noted that the earpiece is an exemplary embodiment of an audio output device. It is well within the scope of the invention to utilize a speaker either as part of smartphone 48 or as an auxiliary device. Furthermore, although in a preferred embodiment, described above, the information corresponding to the description of an item stored in database 44 is stored as a text message as described above, it is well within the scope of the invention to store the information as a sound file; removing the necessity to convert text to audio signals as speech. This speeds up processing.

By providing a system which converts code to text, and then to an audio signal, a system is provided, which, on the fly, can make use of codes which have data stored therein as well as corresponding to data stored elsewhere. This provides a more dynamic system capable of operating on a variety of codes in both complexity and robustness of information contained therein. Furthermore, by placing the camera on the bridge of a pair of glasses, the camera automatically captures codes of interest to the user, as the user moves their head towards persons or objects in a manner similar to what sighted persons would do to naturally identify objects or people of interest utilizing their eyes. By using two distinct types of codes, the information within the optical code is only spoken if a particular trigger, T1, is contained within the code. Otherwise, if no trigger is present, no operation is performed on the code, and if the T2 trigger is present, the actual code is not spoken, but utilized to obtain other information to be spoken providing great versatility in use and creation of the codes. By utilizing an earpiece, only the user of the system knows that they are utilizing the code to overcome their visual impairment, thus lessening some of the stigma while allowing the visually impaired user to better function in their environment. By placing the camera in a headset, the system is hands free, enabling the user to carry other objects, or make use of an assistance animal.

While this invention has been particularly shown and described to reference the preferred embodiments thereof, it would be understood by those skilled in the art that various changes in form and detail may be made therein without departing from the scope of the invention encompassed by the appended claims.

What is claimed as new and desired to be protected by Letters Patent of the United States is:

1. An apparatus for assisting visually impaired persons comprising:
a headset;
a camera mounted on the headset;
a microprocessor communicating with the camera for receiving an optically read code captured by the camera and converting the optically read code to an audio signal as a function of a trigger contained within the optical code; and
a speaker communicating with the processor for outputting the audio signal.

2. The apparatus of claim 1, further comprising a database, the processor communicating with the database and accessing an address in the database as a function of a text stored in the optically read code and causing an information stored at the address of the database to be output as an audio signal.

3. The apparatus of claim 2, wherein said information is an audio file stored in the database.

4. The apparatus of claim 2, wherein the information is a text message stored in the database.

5. The apparatus of claim 1, wherein the speaker is an earpiece.

6. The apparatus of claim 1, wherein the headset is a pair of eye glasses.

7. The apparatus of claim 6, wherein said eye glasses include a bridge, the camera being mounted on the bridge.

8. The apparatus of claim 1, wherein the optical code captured by the camera contains at least one of a first trigger, a second trigger or no trigger.

9. The apparatus of claim 8, wherein the microprocessor does not process an optical code captured by the camera when the optical code does not contain a processing trigger.

10. The apparatus of claim 1, further comprising an optical code, the optical code containing a first trigger or a second trigger.

11. An apparatus for assisting visually impaired persons comprising:
a pair of eye glasses having a bridge;
a camera mounted on the bridge;
a microprocessor communicating with the camera for receiving an optically read code captured by the camera and converting the optically read code to an audio signal as a function of a trigger contained within the optical code;
a database, the processor communicating with the database and accessing an address in the database in response to the trigger contained within the optical code, and as a function of a text stored in the optically read code, and causing an information stored at the address in the database to be output as the audio signal; the information being one of an audio file or a text message; and
an earpiece communicating with the processor for outputting the audio signal.

12. A method for identifying persons and objects comprising the steps of:
mounting a camera on a headset;
providing a microprocessor in communication with the camera;
capturing an optically readable code and determining whether a first or second trigger is contained within the code;
converting the optical code to an audio signal only when a first trigger is detected; and
outputting the audio signal to an earpiece.

13. The method of claim 12, further comprising the steps of:
detecting a second trigger in the optically read code;
accessing an address in a database corresponding to a unique identifier text contained within the optical code; and
outputting the information stored in the database at the address as an audio signal to the earpiece.

14. The method of claim 12, wherein the headset is a pair of eye glasses.

15. The method of claim 12, wherein the information stored at the accessed address is an audio file.

16. The method of claim 12, wherein the information stored at the accessed address is a text message; and further comprising the steps of converting the text message to an audio signal.

17. The method of claim 12, wherein the optical code has a density of less than 100 text characters.

18. A method for initializing a system for visually impaired persons to identify persons and objects comprising the steps of:
providing a headset and a camera mounted on the headset;
capturing an optical code containing a unique alphanumeric identifier;
recording an audio description of an item;
storing the audio description in a database at an address of the database; and
mapping the address of the database to the unique alphanumeric identifier of the captured optical code.

19. The method of claim 18, further comprising the step of affixing the code to an item corresponding to the recorded message.

20. The apparatus of claim 1, wherein said optically readable code has three dimensions.
